(19) United States
(12) Patent Application Publication
(10) Pub. No.: US 2005/0163210 A1
(43) Pub. Date: Jul. 28, 2005

(54) Usage of digital input/output card as MPEG transport streamer

(76) Inventors: Shiv Kumar Gupta, Bangalore (IN); Ravi Ilpakurty, Bangalore (IN)

Correspondence Address: Christopher C. Winslade;McAndrews, Held & Malloy, Ltd., 34th Floor, 500 West Madison St., Chicago, IL, 60661, US

(21) Appl. No.: 10/765,800

(22) Filed: Jan. 27, 2004

(51) Int. Cl. H04B 1/66

(52) U.S. Cl. 375/240

(57) ABSTRACT

Described herein is the usage of a digital input/output card as an MPEG transport stream. A transport stream feeder for verifying a video decoder is presented. The transport stream feeder comprises a digital input/output card. The digital input/output card comprises a first memory, a processor, and a second memory. The first memory stores a reference video. The processor encodes the reference video. The second memory stores a decoded reference video, the decoded reference video decoded by the video decoder.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The verification of an MPEG video decoder chip includes feeding a transport stream representing a reference video to the MPEG video decoder chip. The MPEG video decoder chip decodes the transport stream, resulting in a recovered video. The recovered video is recorded for comparison to the reference video.

However, the equipment for the foregoing verification is quite costly. The equipment can cost in the range of $40,000 to $80,000.

Further limitations and disadvantages of conventional and traditional approaches will become apparent to one of skill in the art, through comparison of such systems with embodiments presented in the remainder of the present application with references to the drawings.

### BRIEF SUMMARY OF THE INVENTION

Described herein is the usage of a digital input/output card as an MPEG transport stream.

In one embodiment, there is presented a transport stream feeder for verifying a video decoder. The transport stream feeder comprises a digital input/output card. The digital input/output card comprises a first memory, a processor, and a second memory. The first memory stores a reference video. The processor encodes the reference video. The second memory stores a decoded reference video, the decoded reference video decoded by the video decoder.

In another embodiment, there is presented a transport stream feeder for verifying a video decoder. The transport stream feeder comprises a digital input/output card. The digital input/output card comprises a first memory, a processor connected to the first memory, and a second memory connected to the processor. The first memory stores a reference video. The processor encodes the reference video. The second memory stores a decoded reference video, the decoded reference video decoded by the video decoder.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing the encoding process of an exemplary video in accordance with the MPEG standard;

FIG. 2 is a block diagram of video decoder system in accordance with an embodiment of the present invention;

FIG. 3 is a block diagram of a system for verification of a video decoder in accordance with an embodiment of the present invention;

FIG. 4 is a block diagram of a system for verification of a video decoder in accordance with another embodiment of the present invention;

FIG. 5 is a flow diagram for verifying a video decoder in accordance with an embodiment of the present invention.

### DETAILED DESCRIPTION OF THE INVENTION

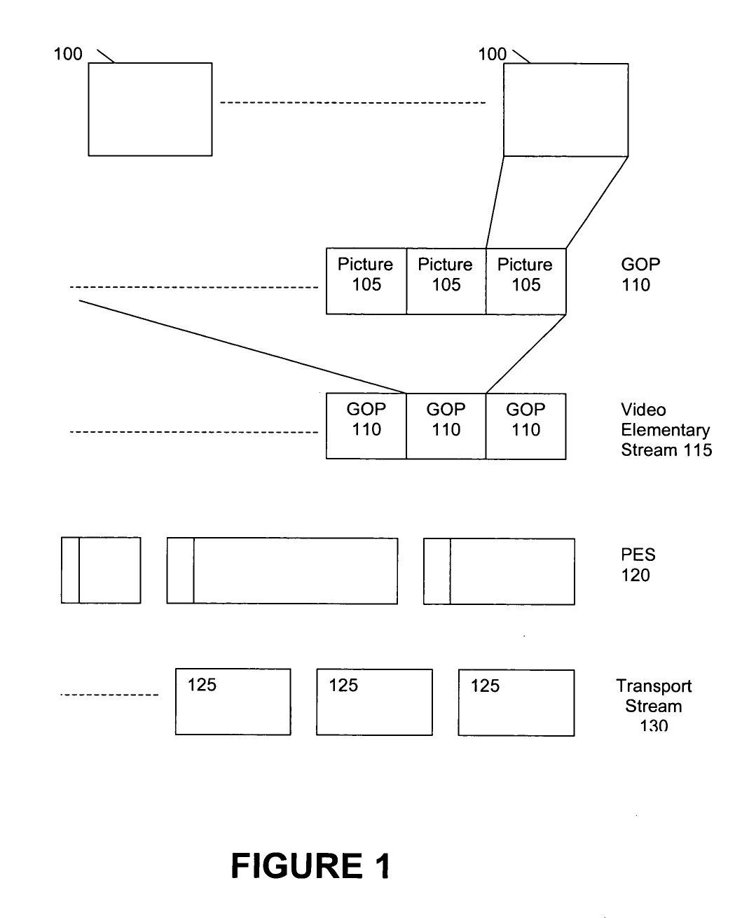

Referring now to FIG. 1, there is illustrated a block diagram describing the encoding process of an exemplary video, in accordance with the MPEG standard. The video comprises a series of frames 100. The frames 100 are encoded into data structures known as pictures 105. The pictures are further encoded into a data structure known as a group of pictures 110. A video elementary stream 115 represents the video and comprises any number of groups of pictures 110.

The video elementary stream 115 is packetized, forming what is known as a packetized elementary stream (PES) 120. The packetized elementary stream (PES) 120 is then further packetized into MPEG transport packets 125, forming what is known as an MPEG transport stream 130. MPEG transport packets 125 from a variety of different packetized elementary streams (including audio and video) can be multiplexed and transmitted over a communication channel.

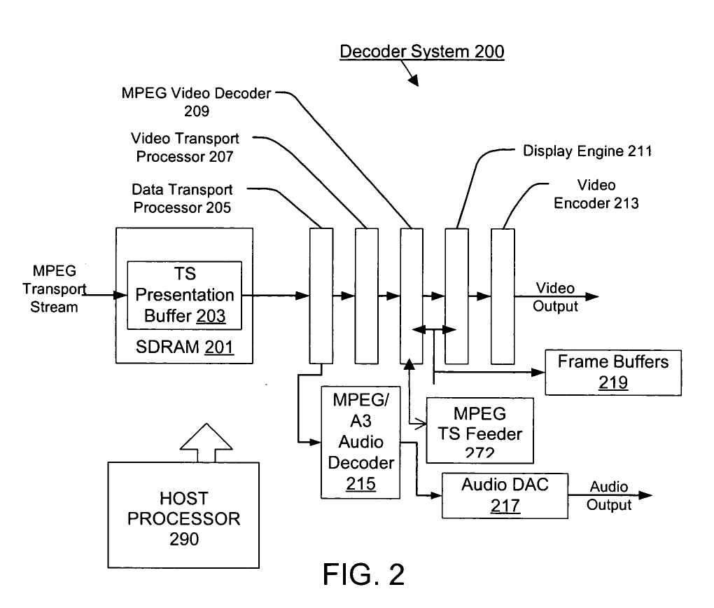

Referring now to FIG. 2, there is illustrated a block diagram describing an exemplary decoder system 200 for providing frames for display to a display device in accordance with an embodiment of the present invention. A processor, that may include a CPU 290, reads transport stream 130 into a transport stream buffer 203 within an SDRAM 201.

The data is output from the transport bitstream buffer 203 and is then passed to a data transport processor 205. The data transport processor 205 then demultiplexes the transport stream 130 into constituent transport streams. The constituent transport streams can include for example, video transport streams 130, and audio transport streams. The data transport processor 205 passes an audio transport stream to an audio decoder 215 and a video transport stream to a video transport processor 207.

The video transport processor 207 converts the video transport stream into a video elementary bitstream and provides the video elementary bitstream to a video decoder 209. The video decoder 209 decodes the video elementary bitstream, resulting in a sequence of decoded video frames. The decoding can include decompressing the video elementary bitstream. The decoded video data includes a series of frames. The frames are stored in a frame buffer 219. The display engine 211 is responsible for providing a bitstream to a display device, such as a monitor or a television.

For verification of the MPEG video decoder 209, an MPEG transport stream feeder 272 feeds an MPEG transport stream 130 to the SDRAM 201. The MPEG transport stream feeder 130 is configured to transmit a video [or is it the video elementary stream?] in accordance with the MPEG video protocol, thereby resulting in an MPEG transport stream 130.

Responsive thereto, the decoder system 200 decodes the transport stream thereby resulting in a video output. The decoder system 200 then transmits the video to the MPEG transport stream feeder 272. The MPEG transport stream feeder 272 records the decoded video for comparison to a reference video.

The decoder system 200 can be implemented as an integrated circuit. Prior to the fabrication of the integrated circuit, the design of the integrated circuit is tested and verified. The design of the integrated circuit can be verified by a device known as an emulator. An emulator is a device that comprises logic gates and other circuitry that can be configured to realize the design of an integrated circuit, except at a much slower clock cycle. The emulator can be configured to realize the design of an integrated circuit by providing an electronic computer file defining the design.

When the emulator is configured to realize the design of the integrated circuit, the MPEG transport stream can be fed to the emulator configured to realize the decoder system 209.

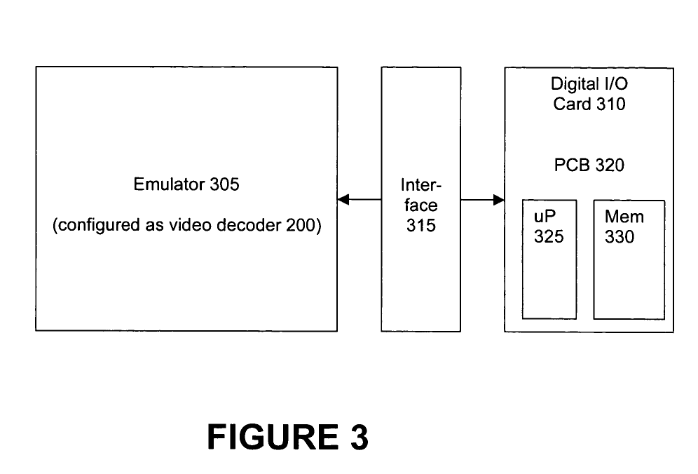

Referring now to FIG. 3, there is illustrated a block diagram of a system for verifying a decoder system 200 in accordance with an embodiment of the present invention. An emulator 305 comprising logic and additional circuitry is configured to realize the design of a decoder system 200 under test.

An MPEG transport stream feeder 272 feeds an MPEG transport stream 130 to the emulator 305. Responsive thereto, the emulator 305 decodes the transport stream, thereby resulting in a video. The emulator 305 then transmits the video to the MPEG transport stream feeder 272.

The MPEG transport stream feeder 272 records the decoded video for comparison to a reference video. The MPEG transport stream feeder 272 comprises a general purpose digital input/output card 310 and an interface card 315. The digital input/output card 310 comprises a printed circuit board 320 with a processor 325 and memory 330. The memory 330 includes a portion that stores instructions which are executed by the processor 325 and a portion that stores data.

The memory 330 stores an initial reference video data. In one mode of operation, the processor 325 executes instructions from the memory 330 causing the generation and transmission of a transport stream representing the reference video data to the emulator 305 via the interface card 315. In another mode of operation, the processor 325 executes instructions causing the receipt and storage of the decoded video data from the emulator 305. The particular mode of operation can be controlled by means of a user provided input.

Many general purpose digital input/output cards 310 do not plug in directly into emulators 305. Accordingly, the interface card 315 works as an adaptor to interface the digital input/output card 310 with the emulator.

The speed of the verification of the video decoder 209 can be increased by configuring the emulator 305 to emulate multiple instances, N, of the decoder system 200. The foregoing can be achieved by using the techniques described in “Parallel Instances of a Plurality of Systems on Chip in Hardware Emulator Verification”, U.S. application Ser. No. 10/685,762 filed Oct. 13, 2003 by Gupta, and incorporated herein by reference for all purposes, wherein each parallel design is the design of the decoder system 200. Digital input/output cards 310 as described above can feed a different MPEG transport stream to each of the N instances of the decoder system 200 configured in the emulator 305, and record the resulting decoded videos for comparison with associated reference videos. As a result, the decoder system 200 design can be tested by N transport streams at a time, and accordingly, verified faster by a factor of N.

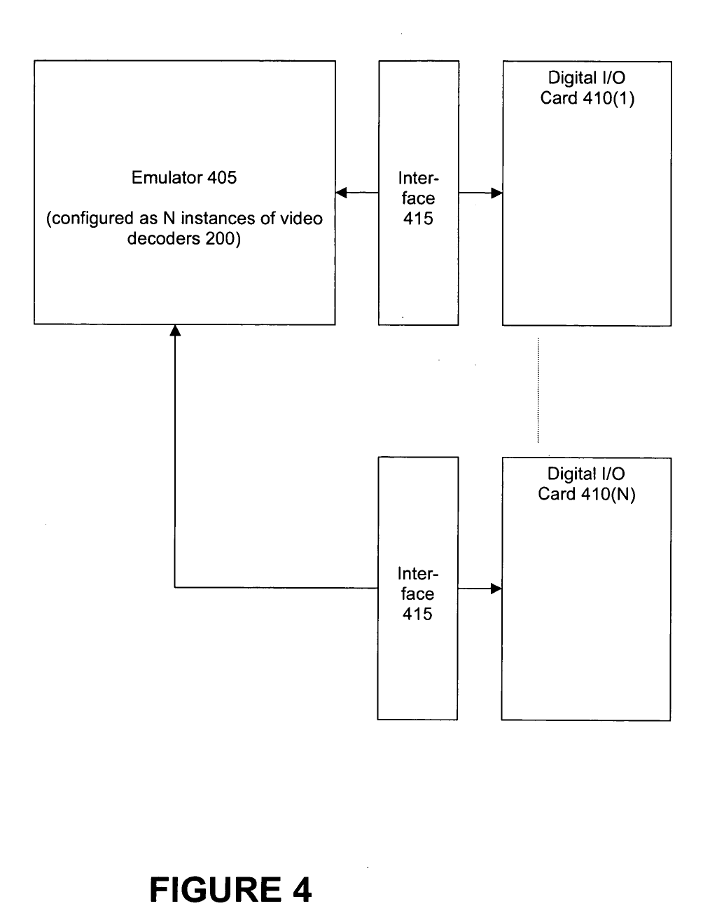

Referring now to FIG. 4, there is illustrated a block diagram describing a system for verifying a decoder system 200 in accordance with another embodiment of the present invention. The emulator 405 is configured to realize the design of N instances of decoder system 200 under test.

Each of the N instances of the decoder system 200 under test is associated with a particular one of N digital input/output card 410 as described above. Each of the digital input/output cards 410 feed a different transport stream to the instance of the decoder system 200 associated therewith, record the decoded video from the instance of the decoder system 200, associated therewith, and compare the decoded video with a reference video.

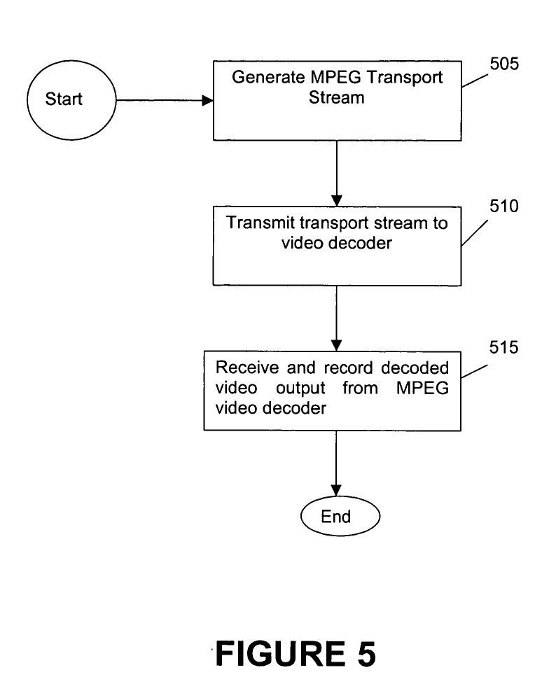

Referring now to FIG. 5, there is illustrated a flow diagram for verifying a decoder system 200. The MPEG Transport Stream feeder generates (505) an MPEG transport stream representing the reference video and transmits (510) the transport stream to the decoder system 200. After transmitting the transport stream to the MPEG Video Decoder 209, the MPEG transport stream feeder 272 waits for the MPEG video decoder 209 to decode the transport stream. At 515, the MPEG transport stream feeder 272 receives and records the decoded video output from the decoder system 200.

The foregoing represents an inexpensive way to verify video decoders by feeding an MPEG transport stream. Digital input/output cards are also widely available. This is particularly the case during parallel testing where N digital input/output cards are used, in contrast to N testing devices.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A transport stream feeder for verifying a video decoder, said transport stream feeder comprising:
a digital input/output card, said digital input/output card comprising:
a first memory for storing a reference video;
a processor for encoding the reference video; and
a second memory for storing a decoded reference video, the decoded reference video being decoded by the video decoder.

2. The transport stream feeder of claim 1, wherein the digital input/output card further comprises:
an interface for transmitting the reference video to the video decoder.

3. The transport stream feeder of claim 1, further comprising:
an adapter for connecting the digital input/output card to the video decoder.

4. The transport stream feeder of claim 1, wherein the digital input/output card further comprises:
a third memory for storing a plurality of instructions executable by the processor, wherein execution of the plurality of instructions by the processor causes:
encoding the reference video;
transmitting the encoded reference video;
receiving the decoded reference video from the video decoder; and
storing the decoded reference video from the video decoder in the second memory.

5. The transport stream feeder of claim 1, wherein the encoded reference video comprises an MPEG transport stream.

6. A transport stream feeder for verifying a video decoder, said transport stream feeder comprising:
a digital input/output card, said digital input/output card comprising:
a first memory for storing a reference video;
a processor connected to the first memory, the processor for encoding the reference video; and
a second memory connected to the processor, the second memory for storing a decoded reference video, the decoded reference video being decoded by the video decoder.

7. The transport stream feeder of claim 6, wherein the digital input/output card further comprises:
an interface operatively coupled to the processor, the interface for transmitting the reference video to the video decoder.

8. The transport stream feeder of claim 6, further comprising:
an adapter operatively coupled to the interface, the adapter for coupling the digital input/output card to the video decoder.

9. The transport stream feeder of claim 6, wherein the digital input/output card further comprises:
a third memory operatively coupled to the processor, the third memory for storing a plurality of instructions executable by the processor, wherein execution of the plurality of instructions by the processor causes:
encoding the reference video;
transmitting the encoded reference video;
receiving the decoded reference video from the video decoder; and
storing the decoded reference video from the video decoder in the second memory.

10. The transport stream feeder of claim 6, wherein the encoded reference video comprises an MPEG transport stream.
